(19) United States
(12) Patent Application Publication
(10) Pub. No.: US 2012/0235423 A1
(43) Pub. Date: Sep. 20, 2012

(54) AIR CURTAIN INCINERATOR HAVING WASTE HEAT POWER GENERATION

(75) Inventor: Brian M. O'Connor, Palm City, FL (US)

(73) Assignee: AIR BURNERS LLC, Palm City, FL (US)

(21) Appl. No.: 13/502,838

(22) PCT Filed: Oct. 27, 2010
(86) PCT No.: PCT/US10/54311

§ 371 Date: Jun. 1, 2012

Related U.S. Application Data
(60) Provisional application No. 61/255,613, filed on Oct. 28, 2009.

(51) Int. Cl. H02K 7/18; F23G 5/40

(52) U.S. Cl. 290/1 R; 110/233; 110/241

(57) ABSTRACT

A portable air curtain incinerator for burning biomass, such as cleared logs and vegetation, is equipped with heat recovery panels along at least one of the sidewalls of the incinerator's firebox, and a heat transfer medium is cycled through the heat recovery panels and expanded to its gaseous phase by heat released during incineration of the biomass. The gaseous medium is directed to drive the turbine of a generator to generate electricity. The heat transfer medium is condensed, preferably using a local source of cooling water, and the cycle is repeated. The air curtain incinerator may include its own generator, or multiple incinerators may be coupled to a single shared generator.

### FIELD OF THE INVENTION

The invention relates generally to incineration of vegetative waste (biomass) and generation of electrical power therefrom.

### BACKGROUND OF THE INVENTION

Vegetative waste, in particular wood waste, has long been a difficult problem for community landfills and lumbering operations. Grinding the wood waste reduces its volume, but is expensive and extremely harmful to the environment, and it fails to reduce the amount of wood waste. Grinding ten tons of logs yields ten tons of wood chips. In the context of the massive tree kill currently befalling forests in the western United States due to insect infestation and climate change, the approach of grinding, chipping and hauling the wood waste actually spreads the problem.

Fireboxes and fire pits have been used to burn vegetative waste at clearing sites. In order to reduce ash and smoke released during waste incineration (particulate release), a flow of high velocity air has been used to provide an “air curtain” over a fire pit or firebox in which the waste is burned. U.S. Pat. Nos. 4,756,258 and 5,415,113 describe portable apparatus for air curtain incineration. The former patent teaches a fan and manifold assembly that can be towed to and positioned at the edge of a fire pit, whereas the latter patent teaches a firebox, fan, and manifold assembly mounted on a support frame for transport to a desired clearing site for incineration of waste without the need to dig a fire pit. These portable solutions offer clean burning, and they minimize the need to transport the waste.

U.S. Pat. No. 6,536,360 by the present applicant discloses an air-curtain firebox incinerator designed to capture waste heat for useful applications. The heat is recovered from the side walls of the firebox, which radiate between 400 and 600 degrees Fahrenheit, using heat transfer panels to heat circulating water. The heated water is typically pumped to a radiator located in the building or greenhouse where air is heated to either warm a facility or provide process heat.

U.S. Pat. No. 7,063,027 also by the present applicant provides a self-contained, transportable air curtain incinerator for combustion of low calorific value waste. The incinerator comprises a transportable frame supporting a firebox, a fuel supply tank, a fuel-burning electric power generator in communication with the fuel supply tank, at least one fuel-burning burner unit in communication with the fuel supply tank for directing a flame into a combustion chamber defined by the firebox, and an air curtain blower powered by the generator for providing a sheet of high velocity air flow generally across an open top of the firebox. Thus, the generator runs on energy from burning fuel in the fuel tank, not on energy from combustion of waste in the firebox. The generated power is used locally in the incinerator apparatus to power the air curtain blower.

Even with the advances mentioned above, biomass incineration facilities currently suffer from three main drawbacks: 1) the waste has to go through a grinder and then a chipper to a achieve particular size acceptable to the incinerator and only about 80% of that waste is acceptable for the incinerator; 2) the incinerators use natural gas to burn the waste; and 3) at today's rates, if the waste has to be transported more than fifty miles to an incinerator the costs are prohibitive. What is needed is a biomass incineration facility that can be setup at a temporary location and operated until the waste transportation costs are too high, and then the whole facility can be easily moved to a new location. The incinerators should not require any fuels to augment burning, and they should accept 100% of the waste materials without any need to process the waste before it is placed into an incinerator. In addition, the incineration facility should allow for capture of energy produced by incinerating the biomass and conversion of that energy to electric power as an economic and environmental benefit.

### SUMMARY OF THE INVENTION

In accordance with a first embodiment of the present invention, a portable air curtain incinerator is equipped with heat recovery panels along at least one of the sidewalls of the incinerator's firebox, and a heat transfer medium is cycled through the heat recovery panels. The heat transfer medium may be expanded to its gaseous phase by heat released during incineration of wood waste or other biomass, and the gaseous medium is directed to drive the turbine of a generator to generate electricity. The electricity may then be conditioned for internal use and/or sale to a utility company. The heat transfer medium is condensed, preferably using a local source of cooling water, and the cycle is repeated.

Alternatively, the heat transfer medium in the heat recovery panels may be kept under pressure so that the heat transfer medium remains in its liquid phase. In that case, the pressurized heat transfer medium is directed to a heat transfer unit containing a refrigerant. The heat from the pressurized heat transfer medium causes the refrigerant to expand, which drives the turbine of a generator to generate electricity.

A second embodiment of the invention comprises a group of portable air curtain incinerators each equipped with heat recovery panels, and a single shared power generator and cooling station connected to the incinerators to receive gaseous or liquid heat transfer medium from each of the incinerators, wherein energy from multiple incinerators may be combined to drive the turbine of the single generator, and a common cooling system may be shared by all the incinerators. Here again, electric power may be conditioned and used for private purposes or sold for public use.

### BRIEF DESCRIPTION OF THE DRAWING VIEWS

The invention will be explained further with reference to drawing figures in which:

FIG. 1 is a perspective view of a portable air-curtain incinerator having an on-board power generator in accordance with a first embodiment of the present invention;

FIG. 2 is a side view of the incinerator shown in FIG. 1;

FIG. 3 is a schematic view of the incinerator shown in FIGS. 1 and 2; and

FIG. 4 is a schematic view of a second embodiment of the present invention, wherein multiple air curtain incinerators are in communication with a single shared power generator.

FIG. 5 is a schematic end view of an incinerator having a heat recovery roof.

### DETAILED DESCRIPTION OF THE INVENTION

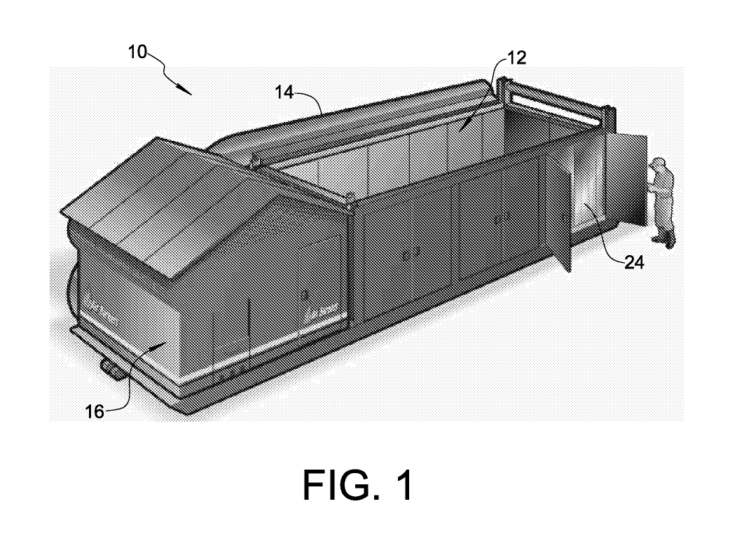

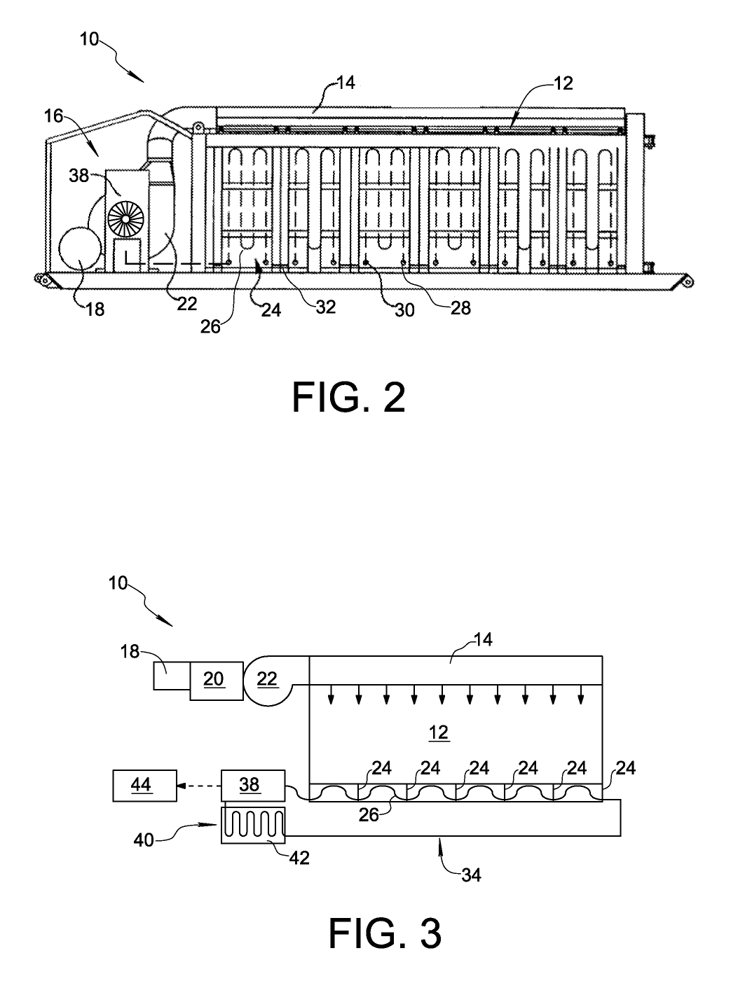

FIGS. 1-3 show a portable air-curtain incinerator 10 capable of cleanly converting biomass into electrical power in accordance with a first embodiment of the present invention. Incinerator 10 generally comprises a firebox 12, an air curtain manifold 14 arranged to direct a curtain of high-velocity airflow over an open top of firebox 12, and an equipment deck 16 adjacent the firebox. Equipment deck 16 supports a fuel tank 18, an engine 20 running on fuel stored in fuel tank 18 or powered by electricity from a local power grid, and a fan 22 driven by engine 20 to generate airflow through air curtain manifold 14. An electrical generator (not shown) may also be included for starting the engine 20 in the case where the portable air-curtain incinerator 10 is being used in a remote connection, with no access to a local power grid. Incinerator 10 may be constructed generally as described in commonly-owned U.S. Pat. No. 5,415,113, the entire disclosure of which is incorporated herein by reference. However, modifications for recovering waste heat and generating electrical power may be implemented as described below in accordance with the present invention.

For recovering waste heat, the sidewalls of firebox 12 are equipped with heat recovery panels 24 having tubing 26 for conducting a flowing heat transfer medium such as an environmentally benign refrigerant or a water solution. For sake of simplicity, the present description refers to a refrigerant, however it will be understood that other heat transfer media may be used. Panels 24 are insulated on the inner exposed side with refractory material. Heat recovery panels 24 may be formed as disclosed in commonly-owned U.S. Pat. No. 6,536,360, the entire disclosure of which is incorporated herein by reference. Alternatively, retrofittable heat recovery panels may be mated to existing thermo-ceramic firebox side panels. Each heat recovery panel includes an inlet port 28 and an outlet port 30. Ports 28 and 30 are fitted with suitable coupling hardware for connecting hose or tubing lines thereto. As may be understood, the outlet port 30 of a given panel 24 may be connected by hose or tubing lines 32 to the inlet port 28 of a next panel, and so on, to provide a continuous flow path for heat transfer medium to traverse substantially the entire length of a sidewall of firebox 12. Retrofittable heat recovery panels may be formed using stainless steel to inhibit corrosion.

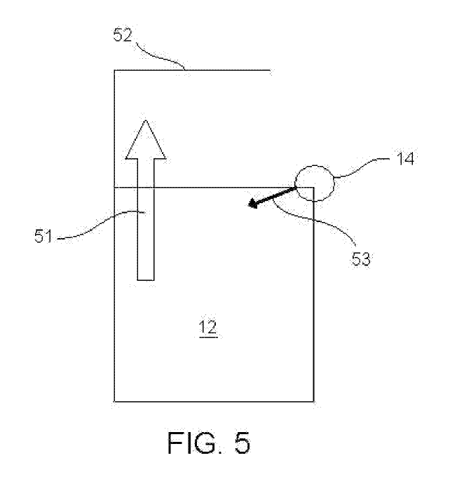

As shown in FIG. 5, heat may also be recovered from above the exhaust plume 51 of the firebox 12 by constructing a partial heat recovery roof 52. Due to the forces of the air curtain 53, the exhaust plume 51 (or compression of exhaust gases) rises up from the wall opposite the air curtain manifold 14. The exhaust plume 51 covers the entire length of the firebox 12, and approximately 20% of the width of the firebox 12. The temperature of the exhaust plume 51 reaches over 1800 degrees Fahrenheit (982.2 degrees Celsius). The partial heat recovery roof 52 may use similar heat recovery panels as the sidewalls of the firebox 12 to recover heat from the incineration of waste.

FIG. 3 shows that tubing 26 and connecting lines 32 are part of a closed refrigerant loop generally indicated by numeral 34. The refrigerant starts at a pump 36 as a liquid and is cycled through heat recovery panels 24 along a sidewall of firebox 12. Heat from incineration of biomass within firebox 12 is transferred to the refrigerant, causing the refrigerant to change from liquid phase to gaseous phase and rapidly expand. The rapidly expanding gas is conveyed to a high speed generator 38 on equipment deck 16, causing the generator's turbine to spin at a very high rate to generate high frequency alternating current (AC Power). The gaseous refrigerant exits generator 38 and travels through a condensing portion 40 of loop 34, which serves to condense the refrigerant to its liquid phase.

Alternatively, the heat transfer medium may be kept under pressure so that it remains in a liquid phase after being heated by the incineration of biomass. The pressurized heat transfer medium is directed to a heat transfer unit containing a refrigerant. The heat from the pressurized heat transfer medium causes the refrigerant to change from liquid phase to gaseous phase and rapidly expand. The rapidly expanding gas is conveyed to a high speed generator 38 on equipment deck 16, causing the turbine to generate electric power. In this case, the heat transfer medium may be water, kept under pressure, which reaches a temperature about 275 degrees Fahrenheit (135 degrees Celsius); however, other liquid mediums may be used.

Condensing portion 40 may be embodied in a variety of ways depending upon the location and use of incinerator 10. The simplest and lowest cost system is to run the refrigerant line through a cool water (about 78 degrees Fahrenheit; 25.6 degrees Celsius) bath 42 where cooling water is drawn from a local pond, stream, lake or well. In this system no cooling water is consumed, lost or contaminated in the process but the water returned to the source will see about a 10 degrees Fahrenheit (5.6 degrees Celsius) increase in temperature. A variant of this would be to use a portable water tank or truck to circulate the water for cooling. The size of the tanker would depend on the size of firebox 12 and the amount of power being generated. Another option is an evaporative cooler which uses a small amount of water run over the heat exchange coils to cool the refrigerant. A further option is an air blast cooler which uses air fans to blow cooling air across a radiator and cool the refrigerant. This option would not use water, but would consume more of the electricity produced by incinerator 10. Waste hot air from the air blast cooler may be used to warm a building or greenhouse.

Generator 38 may include a single stage turbo expander, rated, for example, at 28,000 RPM, and a high speed two-pole rare earth magnet alternator providing, for example, a 100 kWe minimum output. By way of further example, the electrical output may be 380-480 V line-to-line rms 3 phase 4 wire 50/60 Hz 100 kWe minimum.

Generator 38 outputs into a power conditioning module 44 located on equipment deck 16. Power conditioning module 44 controls, distributes and conditions the power coming from generator 38. Power conditioning module 44 may be a PE modulated solid state module programmable to user requirements. First the power is distributed within the incinerator system itself to charge the batteries and to run all the pumps, valves, fans and electronics of the system. This consumes approximately 10% of the available power (except for an air blast cooling system, which would consume an additional 10%). The other 90% is then conditioned for output to the local power grid. Power can be provided at almost any voltage and frequency required, but the most common is 480V three-phase AC power. Power output is dependent in part on the capacity of the incinerator firebox 12. Using an existing firebox configuration such as the Model S220 FireBox available from Air Burners LLC, incinerator 10 will consume between three and six tons of wood waste per hour and is expected to yield a minimum output of about 100 kWe. If a larger firebox configuration is used, such as the Model S327 FireBox from Air Burners LLC, incinerator 10 may generate between 175 and 300 kWe. Incinerator 10 is fully self-contained and easily transportable, making its use possible at multiple sites or communities. On-site connections include the electrical grid and possibly a source of cooling water.

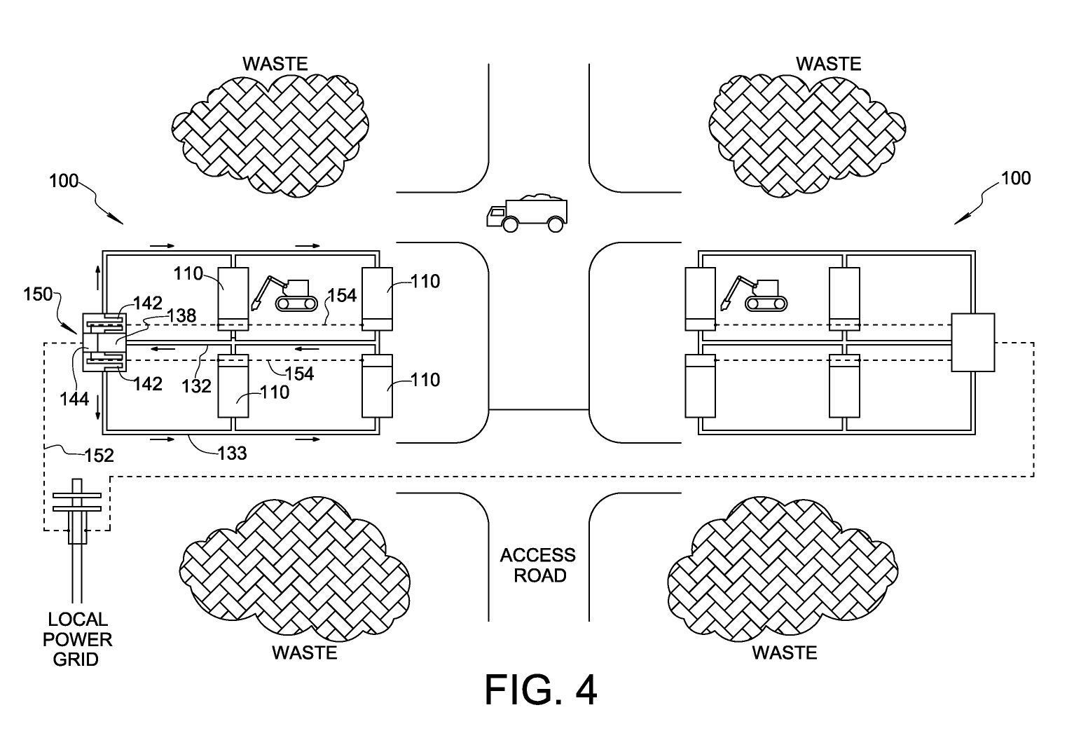

FIG. 4 shows an alternative embodiment 100 of the present invention, wherein multiple air curtain incinerators 110 are in communication with a single shared power generator 138. Generator 138 may be part of a power generation and cooling station 150 located near air curtain incinerators 110. Station 150 is shown as further including a condensing system in the form of a cooling water bath 142 (other condensing systems may be used as discussed above), and a power conditioning module 144. Gas phase refrigerant is carried by conduit 132 from incinerators 110 to station 150 to rotate the turbine of generator 138 to generate electrical power. Power conditioning module 144 converts the generated power for distribution along line 152 to the local power grid for general use and along lines 154 to incinerators 110 for powering components of each incinerator 110 that run on electrical power. Refrigerant is cooled and returned to its liquid phase as it is conveyed through cooling water bath 142. Conduits 133, equipped with suitable pumping hardware (not shown), carry the condensed refrigerant back to the incinerators 110 to repeat the cycle. As will be appreciated, the embodiment of FIG. 4 requires only one generator for a group of fireboxes, and a large portion of the generated electricity may be sold to a utility company at a profit. It may also be possible to realize additional income from generating and selling carbon credits on the open market (e.g. the Carbon Credit Exchange or “CCX”).

Advantageously, in both embodiments described above, the refrigerant is contained in a closed system and is not expelled or replenished.

The present invention provides a portable system for generating power from large scale biomass incineration. The present invention reduces wood waste by 98%; ten tons of logs in yields about two-hundred pounds of ash out (a clean natural ash which is a highly desirable recycled product for agriculture, growers, nurseries and is also a good landfill cover). The invention also captures energy from the wood waste and converts it to electricity, providing an additional income from the sale of that electricity. The present invention is useful in almost every landfill, transfer station or forestry operation. Air curtain incineration is a well-tested and proven technology that allows for natural burning of clean wood waste while protecting our environment from the smoke typically associated with open burning. Of course, the wood waste has enormous energy potential that may now be realized by the present invention, and significant amounts of electricity may be made available in remote locations.

What is claimed is:

1. A portable incineration apparatus and waste heat power generation system, comprising:
a transportable incinerator defined by a plurality of walls and having an open top and an open bottom, the walls lined with a refractory material to form a combustion chamber;
a source of high velocity air;
a manifold assembly in air transfer communication with the source of high velocity air, the manifold assembly being adapted to direct an effective curtain of high velocity air across the top opening and down into the combustion chamber;
a conduit;
a heat conductive medium disposed in the conduit; and
an electric power generator arranged to be driven by the heat conductive medium.

2. The system of claim 1, wherein the heat conductive medium is heated by conduction.

3. The system of claim 2, wherein the transportable incinerator further comprises a roof located above the open top; and
wherein the conduit is connected to the roof.

4. The system of claim 2, wherein the conduit is attached to at least one of the plurality of walls.

5. The system of claim 2, wherein the conduit is integrally formed in at least one of the plurality of walls.

6. The system of claim 1, wherein the conduit is arranged in a serpentine fashion.

7. The system of claim 1, wherein the heat conductive medium is refrigerant.

8. The system of claim 1, wherein the heat conductive medium is water.

9. The system of claim 1, further comprising batteries to store electric power generated from the generator.

10. The system of claim 1, further comprising a power conditioning module to condition power generated by the generator to power the incinerator.

11. The system of claim 9, wherein the power conditioning module conditions power to be distributed to a local power grid.

12. A method of generating electric power from a portable incinerator, the method comprising the steps of:
providing a transportable incinerator defined by a plurality of walls and having an open top and an open bottom, the walls lined with a refractory material to form a combustion chamber;
directing a stream of high velocity air through a manifold assembly to create an air curtain across the top opening and down into the combustion chamber;
burning waste inside the combustion chamber;
heating by conduction from the burning waste a heat conductive medium;
driving a generator by the heated heat conductive medium to generate electric power.

13. The method of claim 12, wherein burning three to six tons of waste per hour results in a minimum output of about 100 kWe.

14. The method of claim 12, wherein heating the conductive medium causes the conductive medium to change from a liquid phase to a gas phase.

15. The method of claim 14, further comprising the step of condensing the conductive medium from the gas phase to the liquid phase.

16. A portable power generation system, comprising:
a plurality of transportable incinerators, each incinerator comprising:
a plurality of walls and having an open top and an open bottom, the walls lined with a refractory material and operatively associated with the open bottom to form a combustion chamber;
a source of high velocity air;
a manifold assembly in air transfer communication with the source of high velocity air, the manifold assembly being adapted to direct an effective curtain of high velocity air across the top opening and down into each combustion chamber;
a conduit; and
a heat conductive medium disposed in the conduit; and
a single generator arranged to be driven by the heat conductive medium heated by the plurality of combustion chambers.

17. The system of claim 16, further comprising a cooling station having a condensing system to cool the heat conductive medium.

18. The system of claim 16, further comprising a power conditioning module to convert power generated by the generator for distribution to a local power grid.

19. The system of claim 13, further comprising a power conditioning module to convert power generated by the generator for use by the transportable incinerators.

20. A portable incineration apparatus and waste heat power generation system, comprising:
means for forming a transportable combustion chamber;
means for generating high velocity air;
a manifold assembly in air transfer communication with the generating means, the manifold assembly being adapted to direct an effective curtain of high velocity air into the combustion chamber;
a conduit disposed on at least one of the plurality of walls;
a heat conductive medium disposed in fluid communication with the conduit so that the medium passes through the conduit during combustion and is conductively heated; and
a means for generating electricity from the conductively heated medium.
